(19) United States
(12) Patent Application Publication
(10) Pub. No.: US 2010/0246501 A1
(43) Pub. Date: Sep. 30, 2010

(54) CONNECTION CLOSE FOR DISJOINT SERVING SECTORS

(75) Inventors: Rajat Prakash, La Jolla, CA (US); Parag Arun Agashe, San Diego, CA (US); Fatih Ulupinar, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/413,342

(22) Filed: Mar. 27, 2009

(51) Int. Cl. H04W 72/04

(52) U.S. Cl. 370/329

(57) ABSTRACT

Systems and methodologies are described that that facilitate resource reclamation in a wireless communications system having a disjoint serving sector configuration. A mobile device can report activity on a communication link (e.g., forward link or reverse link) to a serving sector that provides a corresponding communication link. For instance, forward link activity can be reported to a reverse link serving sector and/or reverse link activity can be reported to a forward link serving sector. The activity can be analyzed to ascertain overall activity of a mobile device. Based upon the analysis, a serving sector can de-allocate resources to the mobile device.

### BACKGROUND

1. Field

The following description relates generally to wireless communications, and more particularly to employing link activity information to facilitate resource reclamation.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP2, 3GPP long-term evolution (LTE), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

Wireless communication systems oftentimes employ one or more base stations that provide a coverage area. A typical base station can transmit multiple data streams for broadcast, multicast and/or unicast services, wherein a data stream may be a stream of data that can be of independent reception interest to an access terminal. An access terminal within the coverage area of such base station can be employed to receive one, more than one, or all the data streams carried by the composite stream. Likewise, an access terminal can transmit data to the base station or another access terminal.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described related to techniques that facilitate resource reclamation in disjoint serving sector configurations. Disparate sectors can separately serve forward and reverse links for a mobile device. In such disjoint serving sector configurations, inactivity of a mobile device can be ascertained through activity reporting. A mobile device can report activity on a communication link (e.g., forward link or reverse link) to a serving sector that provides a complimentary communication link. For instance, forward link activity can be reported to a reverse link serving sector and/or reverse link activity can be reported to a forward link serving sector. The activity can be analyzed to ascertain overall activity of a mobile device. Based upon the analysis, a serving sector can de-allocate resources to the mobile device. According to an example, activity information can include a flag that indicates activity or no activity, one or more indicators that specify activity or no activity on different quality of service (QoS) classes, a number of packets exchanged, indicators that differentiate control signaling activity and data activity, and/or indicators that differentiate types of control signaling messages.

According to an aspect, a method for facilitating allocation of resources in disjoint serving sectors is described herein. The method can comprise monitoring traffic on a communication link. The method can also include generating activity information related to traffic on the communication link, wherein the activity information includes at least a number of packets exchanged on the communication link. In addition, the method can comprise transmitting activity information to at least one base station.

A second aspect described herein relates to a communication apparatus. The communication apparatus can comprise a processor coupled to memory, wherein the processor is configured to implement an activity monitor module that observes activity on at least one communication link, wherein the activity monitor module monitors a quantity of activity and a type of traffic that creates the activity. In addition, the processor can be configured to implement an activity messaging module that generates activity information related to the observed activity on the communication link, wherein the activity messaging module incorporates the activity information in a keep-alive message transmitted to at least one base station in an active set.

A third aspect relates to a wireless communication apparatus that facilitates connection management in disjoint serving sector configurations. The wireless communication apparatus can comprise means for monitoring traffic on a communication link. The wireless communication apparatus can also include means for generating activity information related to traffic on the communication link, wherein the activity information includes at least a number of packets exchanged on the communication link. The wireless communication apparatus can further comprise means for incorporating the activity information in a keep-alive message. In addition, the wireless communication apparatus can include means for transmitting the keep-alive message to members of an active set.

A fourth aspect described herein relates to a computer program product, which can comprise a computer-readable medium that comprises code for causing a computer to monitor traffic on a communication link. The computer-readable medium can further include code for causing the computer to generate activity information related to traffic on the communication link, wherein the activity information includes at least a number of packets exchanged on the communication link. In addition, the computer-readable medium can comprise code for causing the computer to transmit activity information to at least one base station.

Another aspect described herein relates to a method for facilitating allocation of resources. The method can include obtaining activity information from a mobile device, wherein the activity information relates to traffic associated with the mobile device on at least one communication link. The method can also comprise analyzing the activity information to identify a level of activity on the communication link. In addition, the method can include reclaiming resources assigned to the mobile device when the level of activity is below a threshold.

Yet another aspect relates to a communication apparatus comprising a memory that retains activity information obtained from a mobile device. The communication apparatus can further comprise a processor, coupled with the memory, configured to analyze the activity information to identify a level of activity on the communication link and deassign resources allocated to the mobile device when the level of activity is below a pre-determined threshold.

Still another aspect relates to a wireless communication apparatus that comprises means for obtaining activity information from a mobile device, wherein the activity information relates to activity at least one communication link. The wireless communication apparatus can further include means for evaluating the activity information to identify a level of activity on the least one communication link. The wireless communication apparatus can additionally comprise means for comparing the level of activity with a threshold. In addition, the wireless communication apparatus can include means for reclaiming resources assigned to the mobile device when the level of activity is below the threshold.

An additional aspect described herein relates to a computer program product, which can comprise a computer-readable medium. The computer-readable medium can comprise code for causing a computer to obtain activity information from a mobile device, wherein the activity information relates to activity on a communication link. The computer-readable medium can also include code for causing the computer to evaluate the activity information to identify types of traffic associated with activity on the communication link. The computer-readable medium can further comprise code for causing the computer to disregard activity on the communication link corresponding to at least one of control data traffic or traffic on low priority quality of service classes. Moreover, the computer-readable medium can include code for causing the computer to analyze the activity information to ascertain a number of packets exchanged, wherein the number of packets excludes packets associated with control data traffic or low priority quality of service class traffic. Further, the computer-readable medium can comprise code for causing the computer to compare the number of packets exchanged with a threshold. In addition, the computer-readable medium can include code for causing the computer to reclaim resources assigned to the mobile device when the number of packets is below the threshold.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example system that facilitates connection management through activity reporting in accordance with an aspect.

FIG. 3 is an illustration of an example wireless communications system that facilitates activity monitoring and messaging.

FIG. 4 is an illustration of an example system that facilitates allocation of resources based upon reported activity information.

FIG. 5 is an illustration of an example system that facilitates allocation of resources based upon reported activity information according to an aspect of the subject disclosure.

FIG. 6 is an illustration of an example methodology for generating and reporting activity information.

FIG. 7 is an illustration of an example methodology for reclaiming resources based at least in part on reported activity information.

FIGS. 8-9 are block diagrams of respective wireless communication devices that can be utilized to implement various aspects of the functionality described herein.

FIG. 10 is an illustration of an example wireless network environment that can be employed in conjunction with the various systems and methods described herein.

FIG. 11 is an illustration of an example system that facilitates connection management in disjoint serving sector configurations.

FIG. 12 is an illustration of an example system that facilitates allocation of resources.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, evolved Node B (eNode B or eNB), base transceiver station (BTS) or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (i.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication systems such as code division multiple access (CDMA), time division multiple access (TDMA), frequency division multiple access (FDMA), orthogonal frequency division multiple access (OFDMA), single carrier frequency domain multiplexing (SC-FDMA) and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2).

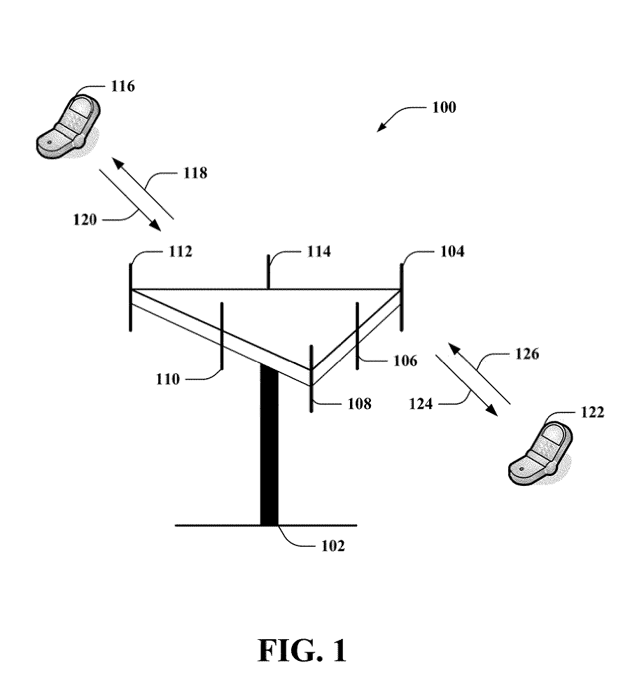

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. This can be provided by using a precoder to steer signals in desired directions, for example. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices. Moreover, mobile devices 116 and 122 can communicate directly with one another using a peer-to-peer or ad hoc technology in one example. Further, system 100 can utilize substantially any type of duplexing technique to divide communication channels (e.g., forward link, reverse link, . . . ) such as FDD, TDD, and the like.

According to an example, system 100 can be a multiple-input multiple-output (MIMO) communication system. MIMO systems commonly employ multiple (N_{T}) transmit antennas and multiple (N_{R}) receive antennas for data transmission. A MIMO channel formed by the N_{T} transmit and N_{R} receive antennas may be decomposed into N_{S} independent channels, which may be referred to as spatial channels, where N_{S}≦{N_{T}, N_{R}}. Each of the N_{S} independent channels corresponds to a dimension. Moreover, MIMO systems may provide improved performance (e.g., increased spectral efficiency, higher throughput and/or greater reliability) if the additional dimensionalities created by the multiple transmit and received antennas are utilized.

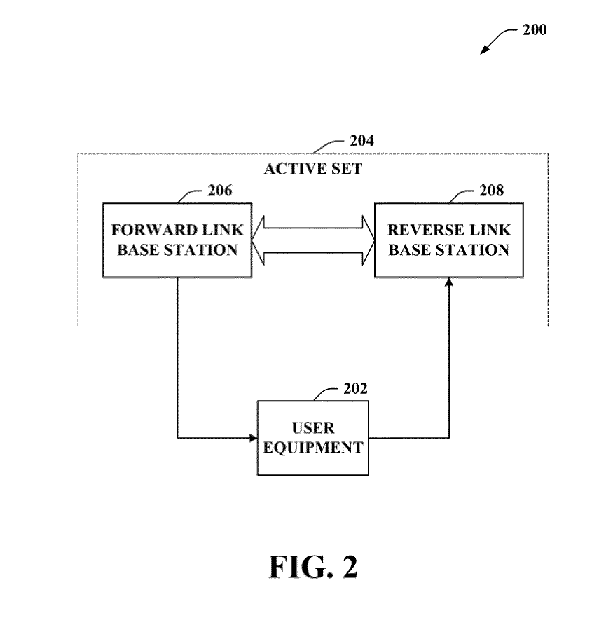

Turning to FIG. 2, illustrated is a system 200 that facilitates connection management through activity reporting. System 200 can be a MIMO system. Additionally, the system 200 can operate in an OFDMA wireless network (such as 3GPP, 3GPP2, 3GPP LTE, etc., for example).

System 200 can include user equipment (UE) 202 capable of wireless communications with base stations and/or other mobile devices (not shown). For example, UE 202 can communicate with members of active set 204. Active set 204 can include base station(s) or sector(s) that have resources assigned to UE 202. For instance, active set 204 of UE 202 can include a forward link base station 206 and a reverse link base station 208. Forward link base station 206 can serve a forward link for UE 204. According to an example, user data to be transmitted to UE 204 can be conveyed by the forward link base station 206. It is to be appreciated that the forward link base station 206 can also be referred to as a forward link serving sector (FLSS). Reverse link base station 208 can obtain user data from UE 204 over a reverse link connection. In other words, reverse link base station 208 can serve a reverse link to UE 204 and can also be referred to as a reverse link serving sector (RLSS). Disjoint serving sectors result when a forward link serving sector differs from a reverse link serving sector.

Typically, in wireless communication systems, base stations can reclaim resources assigned to mobile devices when the mobile devices remain inactive. However, in a disjoint serving sector scenario, the forward link base station 206 can be unaware of activity between the UE 202 and the reverse link base station 208. Similarly, the reverse link base station 208 can be unapprised of activity on the forward link. To assist the forward link base station 206 and/or the reverse link base station 208 to detect activity on a forward or reverse link, the UE 202 can signal a keep-alive message to all members of active set 204. The keep-alive message can be transmitted regularly according to a pre-determined period. The keep-alive message can inform members of active set 204 that UE 202 is within radio service range of at least one active set member.

In an aspect, the keep-alive message can include activity information. The activity information can be forward link activity information and/or reverse link activity information. In an example, the activity information can include an indicator of activity (e.g., forward link or reverse link activity), a plurality of indicators of activity on different QoS classes, a number of packets exchanged for different QoS classes, disparate indicators of control activity and data activity, distinct indicators of activity for different classes of control messages, and any other suitable information that specifies quantity or quality of radio activity of UE 202.

A member of active set 204, such as forward link base station 206 can evaluate the activity information included in the keep-alive message to ascertain UE 202 activity. In an aspect, the forward link base station 206 can obtain reverse link activity information to determine extent of activity on the reverse link. For example, if reverse link activity is below a threshold, the forward link base station 206 can deassign resources allocated to UE 202. In another aspect, the desassigned resources can include all resources assigned to UE 202 by members of active set 204. It is to be appreciated that resources can remain allocated if reverse link activity is below the threshold but UE 204 maintains forward link activity with forward link base station 206. According to another example, the reverse link base station 208 can obtain activity information related to the forward link. The reverse link base station 208 can evaluate the activity information to ascertain if forward link activity meets a threshold and, if not, deassign resources assigned to UE 204.

Moreover, although not shown, it is to be appreciated that user equipment 202, forward link base station 206, reverse link base station 208 can include memory that retains instructions with respect to monitoring link activity, messaging link activity, evaluating link activity, reclaiming resources, etc. Further, user equipment 202, forward link base station 206, and reverse link base station 208 can include processors that can be utilized in connection with executing instructions (e.g., instructions retained within memory, instructions obtained from a disparate source, . . . ).

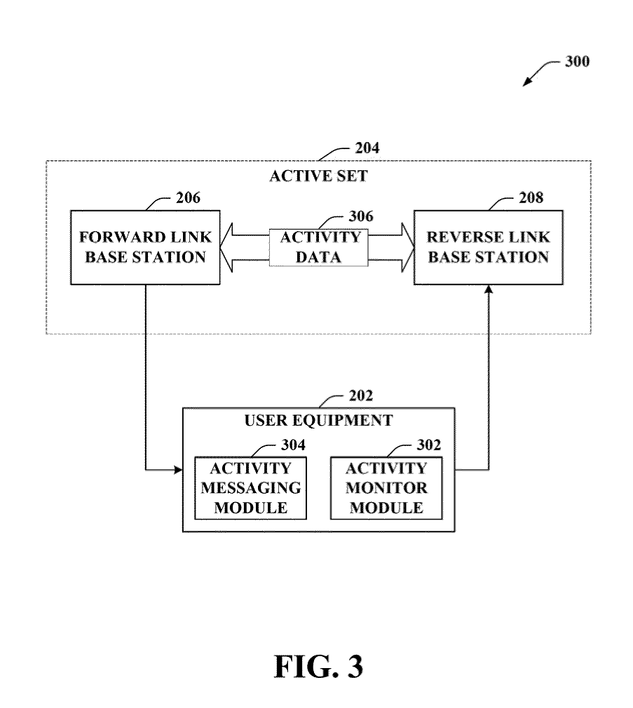

Turning to FIG. 3, illustrated is a wireless communication system 300 that facilitates activity monitoring and messaging. System 300 can include UE 202 that communicates with active set 204. Active set 204 can include base stations and/or sectors having resources assigned to UE 202. The active set 204 can include a forward link base station 206 that serves forward link communications to UE 202 and a reverse link base station 208 that provides reverse link communications to UE 202. It is to be appreciated that UE 202, forward link base station 206, and reverse link base station 208 can be substatantially similar to and perform substantially similar functions as UE 202, forward link base station 206, and reverse link 208 described above with reference to FIG. 2.

According to an aspect, UE 202 can include an activity monitor module 302 that observes activity of UE 202. The activity monitor module 302 can monitor forward link and/or reverse link activity. For instance, the activity monitor module 302 can detect when a communication link is active. In addition, the activity monitor module 302 can perform detailed or granular observations of UE 202 communication activity. In one example, the activity monitor module 302 can separately track activity on disparate QoS classes. QoS classes can include various QoS flows or streams such as, but not limited to, data download applications (e.g., file sharing, torrent, etc.), web traffic, email data traffic, and/or voice traffic. For each QoS class, the activity monitor module 302 can indicate presence or absence of activity.

According to another example, the activity monitor module 302 can monitor a number of packets exchanged between UE 202 and a base station. For instance, the activity monitor module 302 can record forward link packets between UE 202 and forward link base station 206. In addition, the activity monitor module 302 can monitor reverse link packets exchanged between UE 202 and reverse link base station 208. Moreover, the activity monitor module 302 can separately record number of packets exchanged on different QoS classes.

In another aspect, the activity monitor module 302 can detect whether activity on a communication link is control data (e.g., control signaling) or user data. In addition, the activity monitor module 302 can distinguish among control data to indicate a type of control signaling resulting in monitored activity. For example, detected activity can result from timing correction, power control messages, and/or control messages that establish a connection.

According to another aspect, data acquired by the activity monitor module 302 can be retained in a data store (not shown). It is to be appreciated that the data store can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM. The data store is intended to comprise, without being limited to, these and any other suitable types of memory.

UE 202 can also include an activity messaging module 304 that can generate a keep-alive message that includes activity information. The activity information can include data acquired by the activity monitor module 302 and relate to activity on a communication link (e.g., forward link or reverse link). For example, the activity information can include an indication of overall activity, indications of activity of separate QoS classes, a number of total packets exchanged, a number of packets exchanged for each QoS class, indication of control activity versus user data activity, and/or indications of types of control activity (e.g., timing correction, power control, etc.).

In one example, the keep-alive message can incorporate activity information in accordance with the following schema. A single bit can be employed to indicate overall activity. For instance, a zero can indicate no activity and a one can indicate activity. In addition, one or more bits can be utilized to specify activity on different QoS classes. Moreover, two or more bits can be utilized to separately indicate control data activity and user data activity. Separate, granular bits can also be employed to distinguish types of control data activity. For example, timing correction and power control message activity can be distinguished from other control data activity. The keep-alive message can further include fields that encode number of packets exchanged for each QoS class, total number of packets exchanged, number of control data packets, number of user data packets and the like.

UE 202 can transmit the keep-alive message generated by the activity messaging module 304 to all members of the active set 204. For instance, UE 204 can transmit the keep-alive message on the reverse link served by the reverse link base station 208. In addition, UE 204 can utilize an uplink control channel to convey the keep-alive message to forward link base station 206 and/or any other base station (not shown) in active set 204. In another example, UE 202 can tunnel the keep-alive message to members of active set 204 through the reverse link base station 208. UE 202 can transmit the keep-alive message to reverse link base station 206 via the reverse link, for example. The reverse link base station 208 can convey activity data 306 included in the keep alive message to forward link base station 206. The reverse link base station 208 can employ an X2 interface or other suitable backhaul interface between base stations to convey activity data 306.

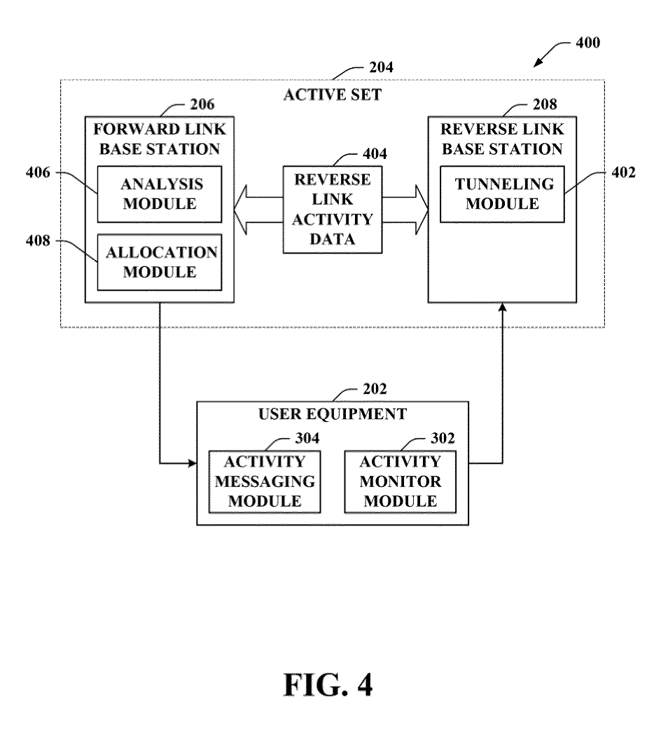

FIG. 4 depicts a system 400 that facilitates allocation of resources based upon reported activity information. System 400 can include UE 202 and active set 204 that comprises at least a forward link base station 206 and a reverse link base station 208. In addition, UE 202 can include activity monitor module 302 that can observe activity on a communication link. For instance, activity monitor module 302 can monitor activity on a reverse link served by reverse link base station 208. UE 202 can also include activity messaging module 304 that can generate a keep-alive message that include activity information. The activity information can include data monitored by the activity monitor module 302.

In an aspect, the activity information can include reverse link activity information. UE 202 can transmit a keep-alive message with reverse link activity information to reverse link base station 208. UE 202 can transmit the keep-alive message on a reverse link control channel, for example. The reverse link base station 208 can include a tunneling module 402 that enables the keep-alive message and/or the activity information to be conveyed to other members of active set 204. For example, reverse link base station 208 can communicate reverse link activity data 404 included in the keep-alive message over a backhaul connection, such as an X2 interface. The reverse link activity data 404 can be obtained by forward link base station 206.

Forward link base station 206 can include an analysis module 406 that evaluates reverse link activity data 404. For instance, the analysis module 406 can ascertain whether reverse link activity exceeds a threshold. The threshold can be a pre-determined parameter. In addition, the threshold can be a parameter established during connection setup negotiations between active set 204 and UE 202. For example, the analysis module 406 can evaluate a number of packets exchanged on the reverse link to check whether the threshold is met. When the threshold is met, the analysis module 406 can render a decision that indicates reverse link activity is sufficient.

It is to be appreciated that the analysis module 406 can perform a variety of analyses on reverse link activity data. In one example, the analysis module 406 can render a result that indicates activity is present or not present. Moreover, the analysis module 406 can render robust results. In another example, the analysis module 406 can evaluate QoS classes associated with reverse link activity. For instance, the analysis module 406 can ascertain that reverse link activity is associated with a data download application and, accordingly, indicate that low priority activity is occurring. In another example, reverse link activity can be associated with voice traffic and, thus, higher priority.

The analysis module 406 can further distinguish activity as a result of control signaling and activity as a result of user data transmissions. For example, the analysis module 406 can ignore control signaling activity on the reverse link. In another example, the analysis module 406 can classify control signaling and ignore only particular types of signaling (e.g., timing corrections, power control, etc.).

Forward link base station 206 can also include an allocation module 408 that can reclaim resources assigned to UE 202 when UE 202 is inactive. The allocation module 408 can employ results and/or decisions from the analysis module 406 to yield resource allocation determinations. For example, the analysis module 406 can evaluate that a small number of packets have been exchanged (e.g., below a threshold) and, accordingly, that resources can be reclaimed. Moreover, the analysis module 406 can ascertain that activity is only present on low priority QoS classes (e.g., download applications) such that resources can be deassigned. Moreover, the analysis module 406 can indicate to the allocation module 408 can reclaim resources when activity is control signaling and/or control signaling of a particular type (e.g., timing corrections, power control, etc.). The allocation module 408 can reclaim resource assigned to UE 202 by other members of active set 204. In other words, all resources assigned by members of active set 204 can remain with UE 202 or all resources can be deallocated.

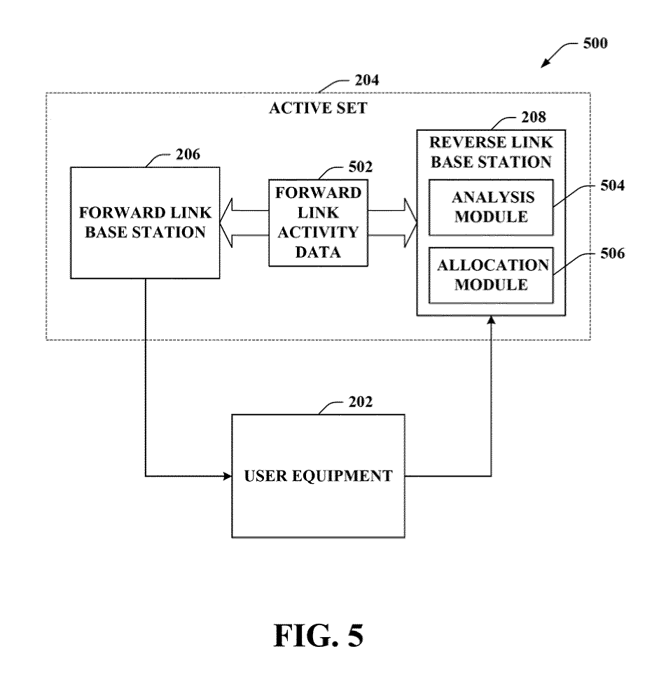

FIG. 5 illustrates a system 500 that facilitates allocation of resources based upon reported activity information. System 500 can include UE 202 and active set 204 as described above. The active set 204 can include a forward link base station 206 and a reverse link base station 208. It is to be appreciated that active set 204 can include one or more additional base stations (not shown) that also allocate resources to UE 202. As described supra with respect to FIGS. 2, 3, and 4, UE 202 can monitor activity on a communication link (e.g., forward link or reverse link) and generate activity information that is transmitted in a keep-alive message. The activity information can be evaluated to ascertain if activity is sufficient in quantity and/or of a particular type to justify maintaining an assignment of resources to UE 202.

In accordance with an aspect, the activity information can relate to forward link activity. UE 202 can transmit a keep-alive message that includes forward link activity information to forward link base station 206. For instance, UE 202 can employ an uplink control channel. The forward link base station 206 can communicate forward link activity data 502 obtained from the keep-alive message. For example, the forward link base station 206 can convey the activity data 502 to reverse link base station 208 via the backhaul.

The reverse link base station 208 can include an analysis module 504 and an allocation module 506. It is to be appreciated that the analysis module 504 and allocation module 506 can be substantially similar to and perform substantially similar functions as analysis module 406 and allocation module 408 described supra with reference to FIG. 4. For example, the analysis module 504 can evaluate forward link activity data to ascertain if forward link activity is present. In addition, the analysis module 504 can ascertain a QoS class associated with forward link activity and/or whether such activity is control signaling. Moreover, the analysis module 504 can determine a quantity of activity (e.g., number of packets exchanged). Based upon evaluation of forward link activity data 502, the analysis module 504 can render a decision on whether resource can remain allocated to UE 202. In accordance with the decision, the allocation module 506 can deassign resources allocated by all members of active set 204.

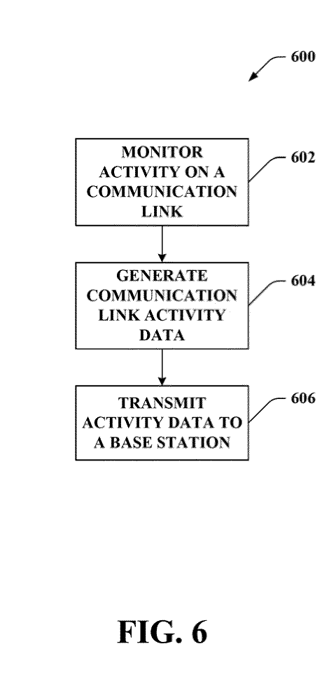

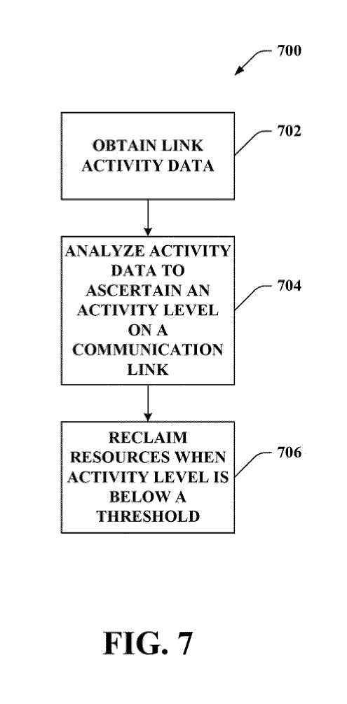

Referring to FIGS. 6-7, methodologies relating reporting activity on a communication link to facilitate resource allocation decisions are described. While for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 6, illustrated is a method 600 that facilitates generating and reporting activity information. Method 600 can be employed, for example, by a mobile device or other communications apparatus such as user equipment 202 to signal activity related to a communication link. At reference numeral 602, activity is monitored on a communication link. The communication link can be, for instance, a forward link served by a forward link base station or serving sector. In addition, the communication link can be a reverse link served by a reverse link base station or serving sector. At reference numeral 604, communication link activity data can be generated. The activity data can include flags that indicate presence or absence of overall activity, activity on disparate QoS classes, activity on control channels, activity on data channels, and/or activity associated with particular control data types. In addition, the activity data can include values that specify a number of total packets exchanged on the communication, packets exchanged for each QoS class, packets of control data, packets of user data and the like. Moreover, the activity data can include a queue size that indicates amount of data queued at a device waiting to be transmitted via the communication link. At reference numeral 606, activity data can be transmitted to a base station. In one example, the base station is not previously aware of the activity. For instance, in disjoint serving sector scenarios, one base station can supply a forward link while another base station serves a reverse link. The reverse link serving station or sector is unaware of activity on the forward link. Similarly, the forward link serving station or sector is unaware of activity on the reverse link. Accordingly, activity data related to a reverse link can be transmitted to a forward link base station and activity data related to a forward link can be transmitted to a reverse link base station.

Referring now to FIG. 7, illustrated is a method 700 that reclamation of resources based at least in part on reported activity information. Method 700 can be performed, for example, by a base station or serving sector with resources assigned to a mobile device. At reference numeral 702, link activity data can be obtained. Activity data can flags that indicate presence or absence of overall activity, activity on disparate QoS classes, activity on control channels, activity on data channels, and/or activity associated with particular control data types. In addition, the activity data can include values that specify a number of total packets exchanged on the communication, packets exchanged for each QoS class, packets of control data, packets of user data and the like.

At reference numeral 704, activity data can be analyzed to ascertain a level of activity on a communication link. For example, flags can be evaluated to determine what type of traffic originates the activity. Priority traffic can be further evaluated while other traffic can be disregarded. Priority traffic can include user data traffic as opposed to control signaling. In addition, certain types or classes of user data traffic can be disregarded. Priority classes such as web traffic, voice traffic and/or email traffic can be further evaluated while low priority classes such as download applications can be ignored. Amount of activity can be compared to a threshold. For instance, a number of packets exchanged on priority traffic can be compared to the threshold to determine a level of activity. At reference numeral 706, resources can be reclaimed when activity level is below a threshold.

It will be appreciated that, in accordance with one or more aspects described herein, inferences can be made monitoring communication link activity, prioritizing communication link activity, analyzing activity data, determining levels of activity, reclaiming resources, and the like. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

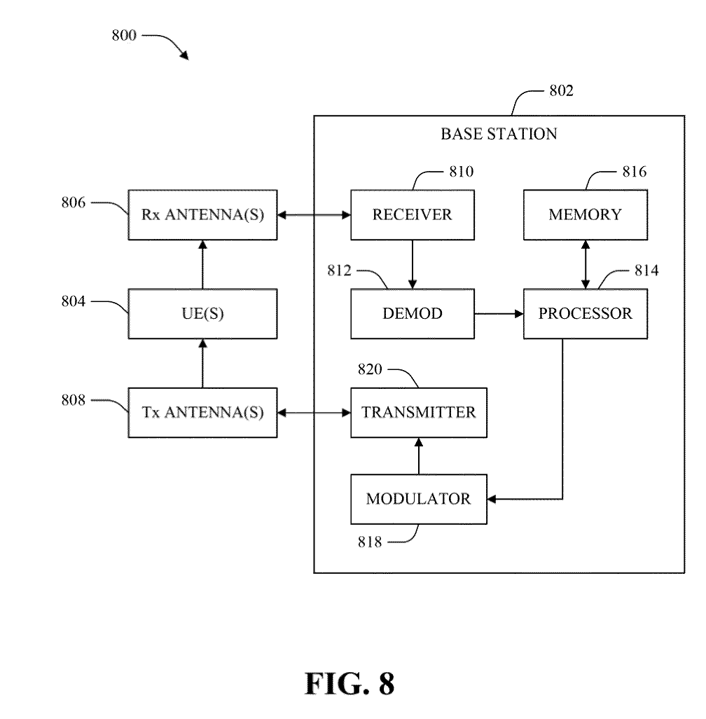

FIG. 8 is a block diagram of a system 800 that can be utilized to implement various aspects of the functionality described herein. In one example, system 800 includes a base station or base station 802. As illustrated, base station 802 can receive signal(s) from one or more UEs 804 via one or more receive (Rx) antennas 806 and transmit to the one or more UEs 804 via one or more transmit (Tx) antennas 808. Additionally, base station 802 can comprise a receiver 810 that receives information from receive antenna(s) 806. In one example, the receiver 810 can be operatively associated with a demodulator (Demod) 812 that demodulates received information. Demodulated symbols can then be analyzed by a processor 814. Processor 814 can be coupled to memory 816, which can store information related to code clusters, access terminal assignments, lookup tables related thereto, unique scrambling sequences, and/or other suitable types of information. In one example, base station 802 can employ processor 814 to perform methodologies 700, and/or other similar and appropriate methodologies. Base station 802 can also include a modulator 818 that can multiplex a signal for transmission by a transmitter 820 through transmit antenna(s) 808.

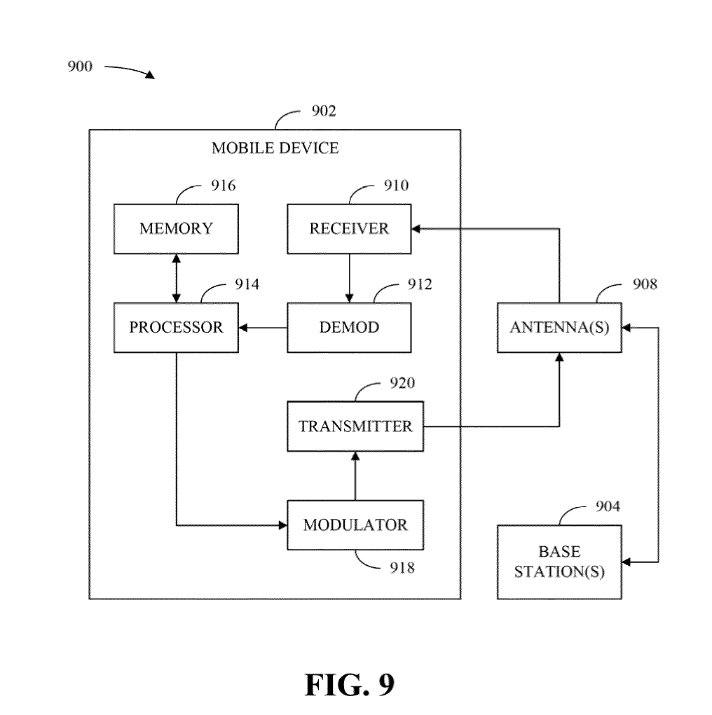

FIG. 9 is a block diagram of another system 900 that can be utilized to implement various aspects of the functionality described herein. In one example, system 900 includes a mobile device 902. As illustrated, mobile device 902 can receive signal(s) from one or more base stations 904 and transmit to the one or more base stations 904 via one or more antennas 908. Additionally, mobile device 902 can comprise a receiver 910 that receives information from antenna(s) 908. In one example, receiver 910 can be operatively associated with a demodulator (Demod) 912 that demodulates received information. Demodulated symbols can then be analyzed by a processor 914. Processor 914 can be coupled to memory 916, which can store data and/or program codes related to mobile device 902. Mobile device 902 can also include a modulator 918 that can multiplex a signal for transmission by a transmitter 920 through antenna(s) 908.

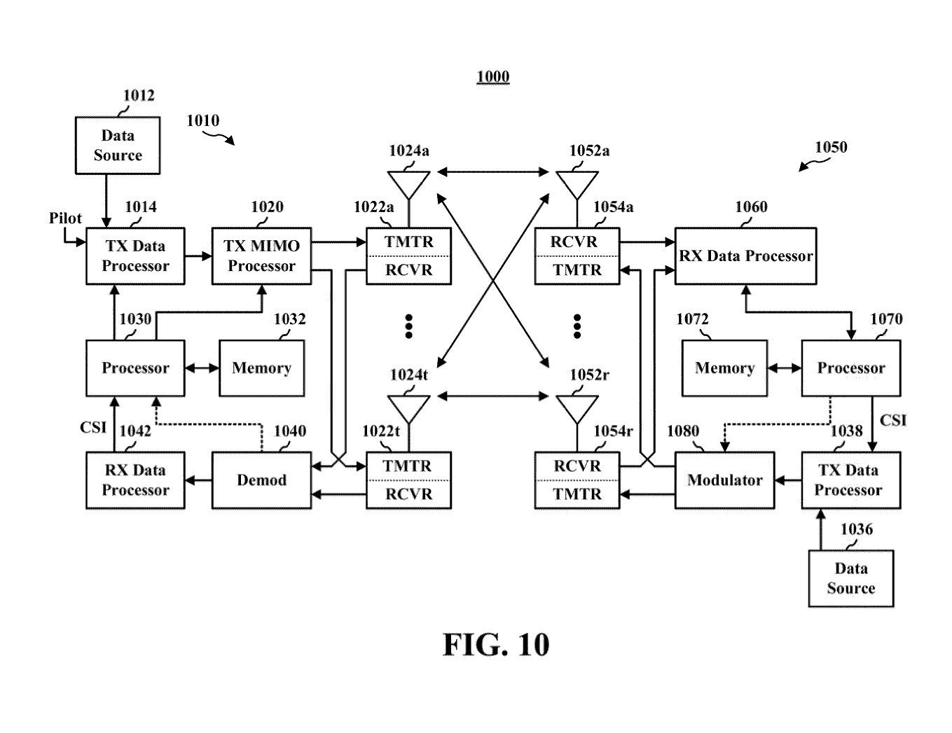

FIG. 10 shows an example wireless communication system 1000. The wireless communication system 1000 depicts one base station 1010 and one mobile device 1050 for sake of brevity. However, it is to be appreciated that system 1000 can include more than one base station and/or more than one mobile device, wherein additional base stations and/or mobile devices can be substantially similar or different from example base station 1010 and mobile device 1050 described below. In addition, it is to be appreciated that base station 1010 and/or mobile device 1050 can employ the systems (FIGS. 1, 2, 3, 4, 5, 8, 9, 11 and 12), and/or methods (FIGS. 6-7) described herein to facilitate wireless communication there between.

At base station 1010, traffic data for a number of data streams is provided from a data source 1012 to a transmit (TX) data processor 1014. According to an example, each data stream can be transmitted over a respective antenna. TX data processor 1014 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1050 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1030.

The modulation symbols for the data streams can be provided to a TX MIMO processor 1020, which can further process the modulation symbols (e.g., for OFDM). TX MIMO processor 1020 then provides N_{T} modulation symbol streams to N_{T} transmitters (TMTR) 1022a through 1022t. In various embodiments, TX MIMO processor 1020 applies beamforming weights to the symbols of the data streams and to the antenna from which the symbol is being transmitted.

Each transmitter 1022 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1022a through 1022t are transmitted from N_{T} antennas 1024a through 1024t, respectively.

At mobile device 1050, the transmitted modulated signals are received by N_{R} antennas 1052a through 1052r and the received signal from each antenna 1052 is provided to a respective receiver (RCVR) 1054a through 1054r. Each receiver 1054 conditions (e.g., filters, amplifies, and downconverts) a respective signal, digitizes the conditioned signal to provide samples, and further processes the samples to provide a corresponding “received” symbol stream.

An RX data processor 1060 can receive and process the N_{R} received symbol streams from N_{R} receivers 1054 based on a particular receiver processing technique to provide N_{T} “detected” symbol streams. RX data processor 1060 can demodulate, deinterleave, and decode each detected symbol stream to recover the traffic data for the data stream. The processing by RX data processor 1060 is complementary to that performed by TX MIMO processor 1020 and TX data processor 1014 at base station 1010.

A processor 1070 can periodically determine which precoding matrix to utilize as discussed above. Further, processor 1070 can formulate a reverse link message comprising a matrix index portion and a rank value portion.

The reverse link message can comprise various types of information regarding the communication link and/or the received data stream. The reverse link message can be processed by a TX data processor 1038, which also receives traffic data for a number of data streams from a data source 1036, modulated by a modulator 1080, conditioned by transmitters 1054a through 1054r, and transmitted back to base station 1010.

At base station 1010, the modulated signals from mobile device 1050 are received by antennas 1024, conditioned by receivers 1022, demodulated by a demodulator 1040, and processed by a RX data processor 1042 to extract the reverse link message transmitted by mobile device 1050. Further, processor 1030 can process the extracted message to determine which precoding matrix to use for determining the beamforming weights.

Processors 1030 and 1070 can direct (e.g., control, coordinate, manage, etc.) operation at base station 1010 and mobile device 1050, respectively. Respective processors 1030 and 1070 can be associated with memory 1032 and 1072 that store program codes and data. Processors 1030 and 1070 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

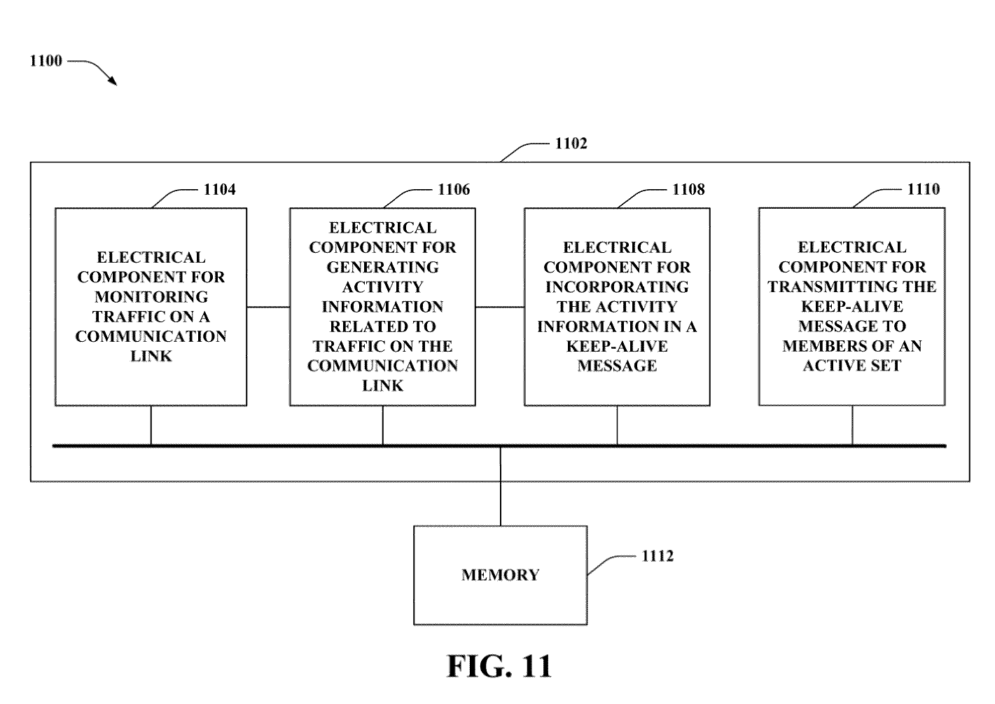

With reference to FIG. 11, illustrated is a system 1100 that facilitates connection management in disjoint serving sector configurations. For example, system 1100 can reside at least partially within a base station, mobile device, etc. It is to be appreciated that system 1100 is represented as including functional blocks, which can be functional blocks that represent functions implemented by a processor, software, or combination thereof (e.g., firmware). System 1100 includes a logical grouping 1102 of electrical components that can act in conjunction. For instance, logical grouping 1102 can include an electrical component for monitoring traffic on a communication link 1104. Further, logical grouping 1102 can comprise an electrical component for generating activity information related to traffic on the communication link 1106. Moreover, logical grouping 1102 can comprise an electrical component for incorporating the activity information in a keep-alive message 1108. Logical grouping 1102 can comprise an electrical component for transmitting the keep-alive message to members of an active set 1110. Additionally, system 1100 can include a memory 1112 that retains instructions for executing functions associated with electrical components 1104, 1106, 1108, and. While shown as being external to memory 1112, it is to be understood that one or more of electrical components 1104, 1106, 1108, and 1110 can exist within memory 1112.

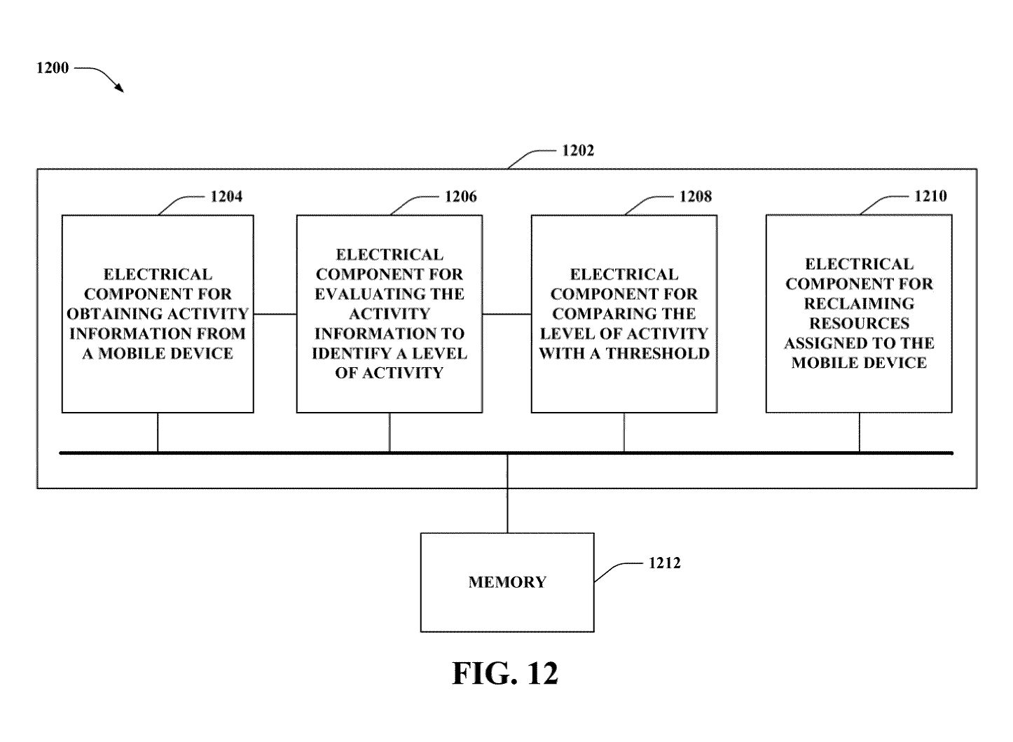

With reference to FIG. 12, illustrated is a system 1200 that facilitates allocation of resources in disjoint serving sector configurations. For example, system 1100 can reside at least partially within a base station, mobile device, etc. It is to be appreciated that system 1200 is represented as including functional blocks, which can be functional blocks that represent functions implemented by a processor, software, or combination thereof (e.g., firmware). System 1200 includes a logical grouping 1202 of electrical components that can act in conjunction. For instance, logical grouping 1202 can include an electrical component for obtaining activity information from a mobile device 1204. Further, logical grouping 1202 can comprise an electrical component for evaluating the activity information to identify a level of activity 1206. Moreover, logical grouping 1202 can comprise an electrical component for comparing the level of activity with a threshold 1208. Logical grouping 1202 can comprise an electrical component for reclaiming resources assigned to the mobile device 1210. Additionally, system 1200 can include a memory 1212 that retains instructions for executing functions associated with electrical components 1204, 1206, 1208, and. While shown as being external to memory 1212, it is to be understood that one or more of electrical components 1204, 1206, 1208, and 1210 can exist within memory 1212.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for facilitating allocation of resources in disjoint serving sectors, comprising:
monitoring traffic on a communication link;
generating activity information related to traffic on the communication link, wherein the activity information includes at least a number of packets exchanged on the communication link; and
transmitting activity information to at least one base station.

2. The method of claim 1, wherein the activity information further includes a flag that indicates one of activity or no activity.

3. The method of claim 1, wherein the activity information further includes a plurality of flags that indicate one of activity or no activity for a set of disparate of quality of service classes.

4. The method of claim 1, wherein the activity information includes indicators that distinguish control signaling activity and user data activity.

5. The method of claim 1, wherein the activity information further comprises separate fields that specify number of packets on different quality of service classes.

6. The method of claim 1, wherein the communication link is a reverse link and the at least one base station is a forward link serving sector.

7. The method of claim 1, wherein the communication link is a forward link and the at least one base station is a reverse link serving sector.

8. A communication apparatus, comprising:
a processor coupled to memory, wherein the processor is configured to implement:
an activity monitor module that observes activity on at least one communication link, wherein the activity monitor module monitors a quantity of activity and a type of traffic that creates the activity; and
an activity messaging module that generates activity information related to the observed activity on the communication link, wherein the activity messaging module incorporates the activity information in a keep-alive message transmitted to at least one base station in an active set.

9. The communication apparatus of claim 8, wherein the activity information includes a flag that indicates one of activity or no activity on the communication link.

10. The communication apparatus of claim 8, wherein the activity information includes a plurality of flags that indicate one of activity or no activity for a set of disparate of quality of service classes.

11. The communication apparatus of claim 8, wherein the activity information includes indicators that distinguish control signaling activity and user data activity.

12. The communication apparatus of claim 8, wherein the activity information includes a number of packets exchanged on the communication link.

13. The communication apparatus of claim 8, wherein the activity information further comprises separate fields that specify number of packets on different quality of service classes.

14. The communication apparatus of claim 8, wherein the communication link is a reverse link and the at least one base station is a forward link serving sector.

15. The communication apparatus of claim 8, wherein the communication link is a forward link and the at least one base station is a reverse link serving sector.

16. A wireless communication apparatus that facilitates connection management in disjoint serving sector configurations, comprising:
means for monitoring traffic on a communication link;
means for generating activity information related to traffic on the communication link, wherein the activity information includes at least a number of packets exchanged on the communication link;
means for incorporating the activity information in a keep-alive message; and
means for transmitting the keep-alive message to members of an active set.

17. The wireless communication apparatus of claim 16, wherein the activity information further includes a flag that indicates one of activity or no activity.

18. The wireless communication apparatus of claim 16, wherein the activity information further includes a plurality of flags that indicate one of activity or no activity for a set of disparate of quality of service classes.

19. The wireless communication apparatus of claim 16, wherein the activity information includes indicators that distinguish control signaling activity and user data activity.

20. The wireless communication apparatus of claim 16, wherein the activity information further comprises separate fields that specify number of packets on different quality of service classes.

21. The wireless communication apparatus of claim 16, wherein the communication link is a reverse link.

22. The wireless communication apparatus of claim 16, wherein the communication link is a forward link.

23. A computer program product, comprising:
a computer-readable medium, comprising:
code for causing a computer to monitor traffic on a communication link;
code for causing the computer to generate activity information related to traffic on the communication link, wherein the activity information includes at least a number of packets exchanged on the communication link; and
code for causing the computer to transmit activity information to at least one base station.

24. The computer program product of claim 23, wherein the activity information further includes a flag that indicates one of activity or no activity.

25. The computer program product of claim 23, wherein the activity information further includes a plurality of flags that indicate one of activity or no activity for a set of disparate of quality of service classes.

26. The computer program product of claim 23, wherein the activity information includes indicators that distinguish control signaling activity and user data activity.

27. The computer program product of claim 23, wherein the activity information further comprises separate fields that specify number of packets on different quality of service classes.

28. The computer program product of claim 23, wherein the communication link is a reverse link and the at least one base station is a forward link serving sector.

29. The computer program product of claim 23, wherein the communication link is a forward link and the at least one base station is a reverse link serving sector.

30. A method for facilitating allocation of resources, comprising:
obtaining activity information from a mobile device, wherein the activity information relates to traffic associated with the mobile device on at least one communication link;
analyzing the activity information to identify a level of activity on the communication link; and
reclaiming resources assigned to the mobile device when the level of activity is below a threshold.

31. The method of claim 30, wherein analyzing the activity information comprises evaluating the information to distinguish types of traffic.

32. The method of claim 31, wherein types of traffic include at least one of control data traffic or user data traffic.

33. The method of claim 32, further comprising disregarding activity associated with control data traffic.

34. The method of claim 31, wherein types of traffic include traffic associated with disparate quality of service classes.

35. The method of claim 34, further comprising ignoring activity associated with low priority quality of service classes.

36. The method of claim 30, further comprising:
identifying a number of packets exchanged on communication link; and
comparing the number of packets with the threshold.

37. A communication apparatus, comprising:
a memory that retains activity information obtained from a mobile device; and
a processor, coupled with the memory, configured to analyze the activity information to identify a level of activity on the communication link and deassign resources allocated to the mobile device when the level of activity is below a pre-determined threshold.

38. The communication apparatus of claim 37, wherein the processor is further configured to disregard activity associated with control data traffic when identifying the level of activity.

39. The communication apparatus of claim 37, wherein the processor is further configured to ignore activity associated with traffic on low priority quality of service classes when identifying the level of activity.

40. The communication apparatus of claim 37, wherein the processor is further configured to identify a number of packets exchanged on communication link and to compare the number of packets with the threshold.

41. A wireless communication apparatus, comprising:
means for obtaining activity information from a mobile device, wherein the activity information relates to activity at least one communication link;
means for evaluating the activity information to identify a level of activity on the least one communication link;
means for comparing the level of activity with a threshold; and
means for reclaiming resources assigned to the mobile device when the level of activity is below the threshold.

42. The wireless communication apparatus of claim 41, wherein activity associated with control data traffic is ignored.

43. The wireless communication apparatus of claim 41, wherein activity associated with traffic on low priority quality of service classes is disregarded.

44. The wireless communication apparatus of claim 41, further comprising:
means for identifying a number of packets exchanged on communication link; and
means for comparing the number of packets with the threshold.

45. A computer program product, comprising:
a computer-readable medium, comprising:
code for causing a computer to obtain activity information from a mobile device, wherein the activity information relates to activity on a communication link;
code for causing the computer to evaluate the activity information to identify types of traffic associated with activity on the communication link;
code for causing the computer to disregard activity on the communication link corresponding to at least one of control data traffic or traffic on low priority quality of service classes;
code for causing the computer to analyze the activity information to ascertain a number of packets exchanged, wherein the number of packets excludes packets associated with control data traffic or low priority quality of service class traffic;
code for causing the computer to compare the number of packets exchanged with a threshold; and
code for causing the computer to reclaim resources assigned to the mobile device when the number of packets is below the threshold.
